(19) United States
(12) Patent Application Publication
(10) Pub. No.: US 2007/0150541 A1
(43) Pub. Date: Jun. 28, 2007

(54) Inbox management for threaded message views

(75) Inventors: Michael E. Carroll, Westford, MA (US); Margo Ezekiel, Newton Centre, MA (US); Niklas Heidloff, Salzkotten (DE); Michael R. O'Brien, Westford, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/318,806

(22) Filed: Dec. 27, 2005

(51) Int. Cl. G06F 15/16

(52) U.S. Cl. 709/206

(57) ABSTRACT

Embodiments of the present invention address deficiencies of the art in respect to inbox management in a messaging system and provide a novel and non-obvious method, system and computer program product for inbox management for threaded message views. In one embodiment, an inbox management method for threaded message views can be provided. The method can include selecting a message in a message list for an inbox, identifying a message thread for the selected message, retrieving all messages for the message thread, and inserting a listing of the retrieved messages for the message thread in the message list.

### BACKGROUND OF THE INVENTION

1. Field of the Invention

The present invention relates to the field of inbox management for messaging systems and more particularly to threaded messages views of an inbox.

2. Description of the Related Art

Electronic messaging represents the single most useful task accomplished over wide-scale computer communications networks. Some argue that in the absence of electronic messaging, the Internet would have amounted to little more than a science experiment. Today, electronic messaging seems to have replaced the ubiquitous telephone and fax machine for the most routine of interpersonal communications. As such, a variety of electronic messaging systems have arisen which range from real-time instant messaging systems and wireless text pagers to asynchronous electronic mail systems.

Electronic mail, a form of electronic messaging referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications, save for voice telephony.

An inbox generally provides for the receipt, classification, storage, and handling of incoming messages. As messages are received, each received message can be viewed and handled according to the preferences of the end user. In most cases, a message can be deleted, stored in a folder, forwarded to a different person or persons, or replied to the sender and optionally any other recipients of the message. Where a single message has been replied to or forwarded repeatedly by and to different parties to the message, a message thread is generated wherein each transmitted message is viewed as a member of the thread. To that end, a message thread can be a messaging analog of a conversation.

Within an inbox, messages can be sorted by time of receipt, by sender, by recipient or by subject. Consequently, all messages in a message thread may not be visible within a single view of an inbox due to the constrained size of the inbox view in a typical display screen. Notwithstanding, viewing a message thread can be helpful when tracking the nature of a conversation represented by the thread. As a result, conventional message processing systems provide for searching facilities able to produce a derived view of a message thread through a careful selection of search terms intended to filter the view of the inbox to include only those messages in a particular message thread.

More advanced forms of the inbox actually provide for a separate, supplemental window displaying a message thread on command. In the more advanced form of the inbox, the supplemental view can be inflexible in comparison to the inbox in that the generated, supplemental view cannot be manipulated to sort the messages in the thread. Furthermore, the generated, supplemental view cannot be viewed in the context of other messages not included as part of the message thread.

### BRIEF SUMMARY OF THE INVENTION

Embodiments of the present invention address deficiencies of the art in respect to inbox management in a messaging system and provide a novel and non-obvious method, system and computer program product for inbox management for threaded message views. In one embodiment, an inbox management method for threaded message views can be provided. The method can include selecting a message in a message list for an inbox, identifying a message thread for the selected message, retrieving all messages for the message thread, and inserting a listing of the retrieved messages for the message thread in the message list.

In one aspect of the embodiment, the method further can include rendering a collapsed message thread indicator adjacent to each message in the message list belonging to a message thread. In another aspect of the embodiment, the method further can include additionally rendering a numeric indication with the collapsed message thread indicator indicating a number of messages in the message thread. In yet another aspect of the embodiment, the method further can include selecting a sorting attribute for all messages in the message list, and sorting the messages in the message list, including the messages in the listing of the retrieved messages, according to the selected sorting attribute.

Notably, in an optional embodiment, inserting a listing of the retrieved messages for the message thread in the message list can include replacing a subject line with message text for each of the retrieved messages, inserting a thread entry in the message list, and applying a subject line of the selected message to a subject line for the thread entry. In this way, a more specific understanding of the content of each message relative to the message thread can be realized by an end user. Also, replacing a subject line with message text for each of the retrieved messages, can include replacing a subject line with a first line of message text for each of the retrieved messages.

In another embodiment of the invention, an inbox management data processing system can be provided. The system can include an inbox manager coupled to a message client. The system further can include a thread view for a message thread embedded among received messages in a message list provided by the inbox manager. Notably, the thread view can be sortable by sorting attribute specified for the message list. In this regard, the thread view can include a thread entry having a subject specified by a selected message in the message thread, and one or more messages in the message thread each having a subject specified by body text for respective ones of the messages.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a message inbox configured to be managed for threaded message views;

FIG. 2 is a schematic illustration of a inbox management data processing system for threaded message views; and,

FIG. 3 is a flow chart illustrating a process for inbox management for threaded message views.

### DETAILED DESCRIPTION OF THE INVENTION

Embodiments of the present invention provide a method, system and computer program product for inbox management for threaded message views. In accordance with an embodiment of the present invention, an inbox view of received messages can be provided. Advantageously, a message in the inbox view belonging to a message thread can be activated for expansion to include an embedded listing of messages in the message thread. In this way, the inbox view not only can include a non-threaded listing of received messages, but also the inbox view can include a threaded listing of messages for a selected message thread.

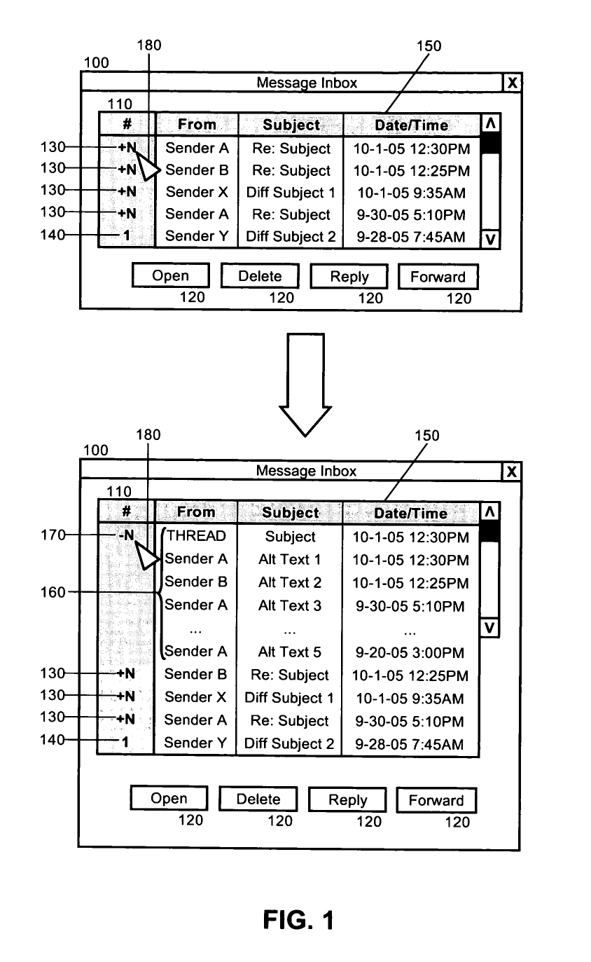

In illustration, FIG. 1 is a pictorial illustration of a message inbox configured to be managed for threaded message views. As shown in FIG. 1, a message inbox 100 can include a message display 110 including one or more received messages. The message inbox 100 can be provide user interface controls 120 to process selected ones of the received messages, including opening a selected one of the received messages for viewing, deleting a selected one of the received messages, replying to a selected one of the received messages, and forwarding a selected one of the received messages, to name only a few operations. Also, the message display 110 can be sorted according to any number of attributes 150 including by sender, subject and date/time.

Notably, a collapsed thread indicator 130 can be associated for each corresponding individual received message which belongs to a message thread can. The collapsed thread indicator 130 optionally can indicate a number of messages in the thread for the corresponding individual received message. For received messages not included as part of a message thread, an ordinary indicator 140 can be provided, for example by indicating that corresponding individual received message is a singular message without related messages in a thread. Of course, no indicator need be provided in an alternative embodiment for messages not belonging to a message thread.

The collapsed thread indicator 130 can be selectable, for instance by pointing device 180 to activate an embedded thread view for a received message associated with the selected collapsed thread indicator 130. Once a collapsed thread indicator 130 has been selected, the message display 110 can be modified to include an embedded listing of messages 160 in a message thread associated with a received message corresponding to the selected thread indicator 130. As such, the selected collapsed thread indicator 130 can transform to an expanded thread indicator 170 so as to indicate the expanded nature of the message thread for the received message. It is to be understood, however, that embedded listing of messages 160 can be collapsed to the original form responsive to a selection of the expanded thread indicator 170.

The embedded listing of messages 160 within the message display 110 can be sorted through the selection of attributes 150 just as in the case where no embedded listing of messages 160 are provided within the message display 110. To facilitate the visual recognition of the embedded listing of messages 160, a first entry in the embedded listing of messages 160 can be provided indicating the presence of a thread and specifying the subject for the thread. For the thread messages listed in the embedded listing of messages 160, however, the respective subjects can be changed to reflect text within each respective message, such as a first line of text. In this way, the nature of each message in the thread will be more readily apparent to the end user.

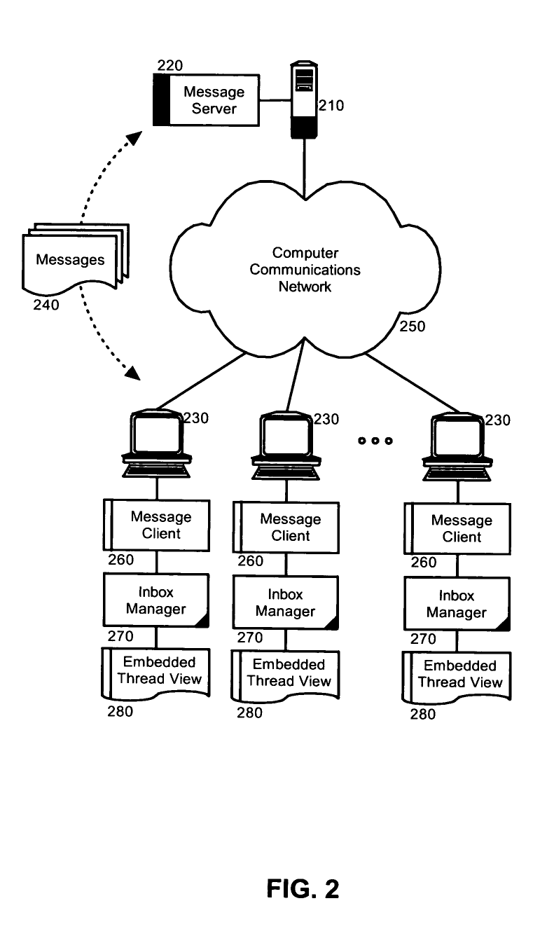

The message display 110 shown in FIG. 1 can be provided within an inbox management data processing system. In further illustration, FIG. 2 is a schematic illustration of a inbox management data processing system for threaded message views. The data processing system can include a message server 220 supported by a server computing platform 210. The message server 220 can be configured for communicative coupling to one or more message clients 260, each supported by respective client computing platforms 230 over a computer communications network 250 such as the global Internet.

Each message client 260 can include an inbox manager 270. The inbox manager 270 can provide message management operational functionality, including the receipt, display, deletion, response and forwarding of messages through a user interface defined by a message display. Notably, the inbox manager 270 further can include program code enabled to render an embedded thread view 280 within the message display. In this regard, the program code can be enabled to process a directive for inline expanding a selected message in the message display to include a listing of all messages in a message thread associated with the selected message. Finally, the program code of the inbox manager 270 can include sorting logic enabled to sort messages listed with the message display, including messages in or more embedded thread views 280.

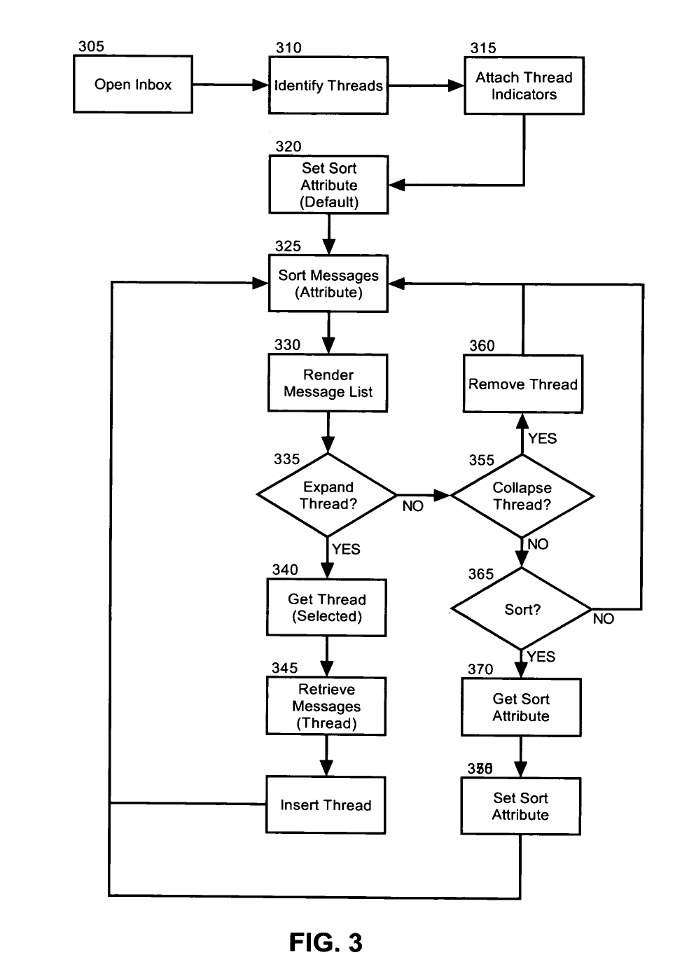

In yet further illustration of the operation of the inbox manager 270, FIG. 3 is a flow chart illustrating a process for inbox management for threaded message views. Beginning in block 305, an inbox can be opened for an end user that can include one or more received messages. In block 310, the message threads for the received messages can be identified and in block 315, a thread indicator can be attached to each message associated with an identified message thread. Finally, in block 320, a sorting attribute can be set to a default value, in block 325 the messages in the inbox can be sorted according to the attribute and in block 330 the message list can be rendered in a display for the inbox.

In decision block 335, it can be determined whether a message thread is to be expanded for a selected message in the message list. If so, in block 340 the message thread for the message list can be determined and in block 345, the messages for the message thread can be retrieved. Subsequently, the retrieved messages can be inserted in the message list. As such, in block 325 the messages in the list, including the messages in the inserted message thread can be sorted according to the sorting attribute and the message list can be rendered 330.

Returning to decision block 355, if it is determined that a message thread is not to be expanded for a selected message in the message list, in decision block 355 it can be determined whether existing messages in an embedded message thread is to be collapsed. If so, in block 360, the existing messages for the selected thread can be removed from display in the message list and the remaining messages in the message list can be sorted according to the sorting attribute in block 325. Subsequently, the message list can be rendered in block 330.

Returning to block 355, if it is determined that existing messages in an embedded message thread are not to be collapsed, in decision block 365 it can be determined whether the messages in the message list are to be sorted. If so, in block 370, a sorting attribute can be determined and in block 375, the new sorting attribute can be applied. Subsequently, in block 325 the messages in the message list can be sorted according to the new sorting attribute, including any messages in a message thread included in the message list. Finally, in block 330, the newly sorted message list can be rendered.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An inbox management method for threaded message views, the method comprising:
selecting a message in a message list for an inbox;
identifying a message thread for the selected message;
retrieving all messages for the message thread; and,
inserting a listing of the retrieved messages for the message thread in the message list.

2. The method of claim 1, further comprising rendering a collapsed message thread indicator adjacent to each message in the message list belonging to a message thread.

3. The method of claim 2, further comprising additionally rendering a numeric indication with the collapsed message thread indicator indicating a number of messages in the message thread.

4. The method of claim 1, further comprising:
selecting a sorting attribute for all messages in the message list; and,
sorting the messages in the message list, including the messages in the listing of the retrieved messages, according to the selected sorting attribute.

5. The method of claim 1, wherein inserting a listing of the retrieved messages for the message thread in the message list, comprises:
replacing a subject line with message text for each of the retrieved messages;
inserting a thread entry in the message list; and,
applying a subject line of the selected message to a subject line for the thread entry.

6. The method of claim 5, wherein replacing a subject line with message text for each of the retrieved messages, comprises replacing a subject line with a first line of message text for each of the retrieved messages.

7. An inbox management data processing system comprising:
an inbox manager coupled to a message client;
a thread view for a message thread embedded among received messages in a message list provided by the inbox manager.

8. The system of claim 7, wherein the thread view is sortable by sorting attribute specified for the message list.

9. The system of claim 7, wherein the thread view comprises:
a thread entry having a subject specified by a selected message in the message thread; and,
a plurality of messages in the message thread each having a subject specified by body text for respective ones of the messages.

10. The system of claim 7, wherein the tread view comprises a collapsed message thread indicator for a message among the received messages belonging to a message thread.

11. The system of claim 10, wherein the collapsed message thread indicator comprises a numeric indicator of a number of messages in the message thread.

12. The system of claim 10, further comprising an expanded message thread indicator for the thread view.

13. A computer program product comprising a computer usable medium having computer usable program code for inbox management for threaded message views, the computer program product including:
computer usable program code for selecting a message in a message list for an inbox;
computer usable program code for identifying a message thread for the selected message;
computer usable program code for retrieving all messages for the message thread; and,
computer usable program code for inserting a listing of the retrieved messages for the message thread in the message list.

14. The computer program product of claim 13, further comprising computer usable program code for rendering a collapsed message thread indicator adjacent to each message in the message list belonging to a message thread.

14. The computer program product of claim 14, further comprising computer usable program code for additionally rendering a numeric indication with the collapsed message thread indicator indicating a number of messages in the message thread.

15. The computer program product of claim 13, further comprising:
computer usable program code for selecting a sorting attribute for all messages in the message list; and,
computer usable program code for sorting the messages in the message list, including the messages in the listing of the retrieved messages, according to the selected sorting attribute.

16. The computer program product of claim 15, wherein the computer usable program code for inserting a listing of the retrieved messages for the message thread in the message list, comprises:
computer usable program code for replacing a subject line with message text for each of the retrieved messages;
computer usable program code for inserting a thread entry in the message list; and,
computer usable program code for applying a subject line of the selected message to a subject line for the thread entry.

17. The computer program product of claim 16, wherein the computer usable program code for replacing a subject line with message text for each of the retrieved messages, comprises computer usable program code for replacing a subject line with a first line of message text for each of the retrieved messages.
